(19) United States
(12) Patent Application Publication
(10) Pub. No.: US 2022/0194232 A1
(43) Pub. Date: Jun. 23, 2022

(54) A VEHICLE BRAKING METHOD AND SYSTEM

(71) Applicant: Aikar Technology Inc., Torrance, CA (US)

(72) Inventors: Chao LU, Mountain View, CA (US); Haili ZHOU, Rancho Palos Verdes, CA (US); Yan SUN, Cerritos, CA (US); Nicholas TEOH, Clyde Hill, CA (US)

(21) Appl. No.: 17/609,286

(22) PCT Filed: May 5, 2020
(86) PCT No.: PCT/US20/31464

§ 371 Date: Nov. 5, 2021

Related U.S. Application Data
(60) Provisional application No. 62/935,743, filed on Nov. 15, 2019.
(60) Provisional application No. 62/923,825, filed on Oct. 21, 2019.
(60) Provisional application No. 62/908,345, filed on Sep. 30, 2019.
(60) Provisional application No. 62/877,061, filed on Jul. 22, 2019.
(60) Provisional application No. 62/866,482, filed on Jun. 25, 2019.
(60) Provisional application No. 62/843,813, filed on May 6, 2019.

(51) Int. Cl. B60L 7/26; B60T 13/58; B60K 1/02

(52) U.S. Cl. CPC B60L 7/26; B60T 13/586; B60K 17/043; B60T 2260/00; B60T 2270/604; B60K 1/02

(57) ABSTRACT

A brake system of a vehicle is disclosed. The braking system includes: a sensor configured to transmit a signal; a brake control unit (BCU) connected to the sensor and configured to determining a braking torque in response to the received signal; an electric motor connected to the BCU and configured to generate the braking torque; a braking mechanism connected to the electric motor to produce an braking effect from the braking torque; and a transmission situated between the braking mechanism and the wheel and configured to amplify the braking effect.

### CROSS REFERENCE TO RELATED APPLICATION

The present application is based on and claims the benefits of priority to the following U.S. Provisional Patent Applications: Ser. No. 62/843,813 filed on May 6, 2019, Ser. No. 62/866,482 filed on Jun. 25, 2019, Ser. No. 62/877,061 filed on Jul. 22, 2019, Ser. No. 62/908,345 filed on Sep. 30, 2019, Ser. No. 62/923,825 filed on Oct. 21, 2019, and Ser. No. 62/935,743 filed on Nov. 15, 2019, the entire contents of which are incorporated herein by reference.

### FIELD

This relates generally to vehicle braking systems and methods, and more particularly, to a mutually integrated drive and brake system utilizing brake-by-wire technology.

### BACKGROUND

Most vehicles today use a conventional hydraulic brake system, which uses brake fluid to transfer pressure from the controlling mechanism to the braking mechanism. When the brake pedal is pressed, the pedal force is amplified by either a vacuum pump or an electric motor within the master cylinder so that the pushrod exerts force on the pistons in the master cylinder, causing fluid from the brake fluid reservoir to flow into a pressure chamber. This results in an increase in the pressure of the entire hydraulic system, forcing fluid through the hydraulic lines toward one or more calipers where it acts upon one or more caliper pistons. The brake caliper pistons then apply force to the brake pads, pushing them against the spinning rotor, and the friction between the pads and the rotor causes a braking torque to be generated, slowing the vehicle. This type of hydraulic brake system requires many parts including hydraulic lines, cylinder blocks, valves, brake reservoir and fluid, etc., which can take significant space in the vehicle and also increase the mass of the vehicle. Furthermore, the traditional hydraulic brake system is mostly analog and, thus, cannot be easily integrated into digital in-vehicle systems such as autonomous driving systems in modern vehicles.

### SUMMARY

In one aspect, this disclosure relates to a mutually integrated drive and brake system for a vehicle. Embodiments of the integrated drive and brake system utilize one or more electric motors of the vehicle to control both the driving and the braking of the vehicle. Individual or multiple brakes can be actuated by one or more electric motors that are part of the vehicle's powertrain unit, whereas the main traction motor or motors provides driving through electromagnetic forces as well as brake forces through regenerative braking and the motors in the friction brake mechanism provide torque so that thrust is established within the system to generate friction torque to brake the vehicle. In one aspect, the braking torque generated by both the traction motor's regenerative braking as well as the friction brakes can be amplified by a transmission before being applied to the wheels of the vehicle.

In another aspect, this disclosure relates to a hybrid braking system for a vehicle (e.g., hybrid or electric vehicle) that is driven by one or more electric motors. The hybrid braking system utilizes a combination of frictional braking, regenerative braking, and induction braking to slow down or stop the vehicle. Also disclosed is a correlated brake blending mechanism that can maximize the utilization of regenerative braking under any circumstances without sacrificing the overall braking effect on the vehicle.

In one embodiment, when the one or more electric motors of the vehicle are running at low revolutions per minute (RPM), typically when the vehicle is in slow speed, regenerative braking may not be sufficient to slow down or stop the vehicle on its own, especially if sudden deceleration is needed in response to a driver input or a signal from an autonomous braking system of the vehicle. To ensure that enough braking force can be generated in response to the driver's input or the signal from the vehicle's automated braking system, the vehicle's friction brakes can be engaged to supplement regenerative braking. Additionally, induction brakes (i.e., eddy current brakes) can also be engaged to enhance the overall braking effect.

To minimize the wear on the friction brakes (e.g., the brake pads and rotors), the disclosed brake blending mechanism can cut off frictional braking when sufficient braking effect can be achieved by regenerative braking alone or a combination of regenerative braking and induction braking. This typically occurs at or around a certain RPM of the electric motor(s) where the effect of induction braking reaches a certain threshold and the combined braking effect of the regenerative brake and induction brakes is sufficient to achieve the desired braking effect on the vehicle.

As the braking torque generated by the induction brakes level off at or near its peak as the RPM of the electric motor(s) continues to increase, the effect of regenerative braking can begin to tail off. Thus, at the higher RPM range, the braking of the vehicle relies primarily on the induction brakes instead of regenerative braking. The friction brakes can remain disengaged.

### BRIEF DESCRIPTION OF THE DRAWINGS

FIG. 1 is a block diagram illustrating the exemplary components of a vehicle, according to an embodiment of the disclosure.

FIG. 2 is a block diagram illustrating the exemplary components of a brake control unit, according to an embodiment of the disclosure.

FIG. 3 is a block diagram illustrating the exemplary components of a vehicle brake unit, according to an embodiment of the disclosure.

FIG. 4 is a flow chart illustrating the exemplary steps in the operation of the braking system of FIGS. 1-3.

FIG. 5 is a diagram comparing braking performances between the braking system of the disclosed embodiments and a traditional hydraulic system.

FIG. 6a-d illustrate the exemplary structures of different transmissions that can be used in the braking systems, according to embodiments of the disclosure.

FIG. 7 is a block diagram illustrating the exemplary components of a vehicle braking system, according to an embodiment of the disclosure.

FIG. 8 is a block diagram illustrating the exemplary modules stored in BCU, according to an embodiment of the disclosure.

FIG. 9 is a graph illustrating the correlation between the motor operating RPM and brake torque from each of three different braking mechanisms, according to an embodiment of the disclosure.

FIG. 10 is a diagram illustrating an exemplary structure of a differential connected to an electric motor, according to an embodiment of the disclosure.

FIG. 11 is a diagram providing a perspective view of a friction brake device, according to an embodiment of the disclosure.

FIG. 12 is a diagram illustrating the structure and components of a friction brake system, according to an embodiment of the disclosure.

FIG. 13 is a diagram providing a top view of the friction brake system of FIG. 12.

FIG. 14 is a diagram illustrating the structure and components of a planetary transmission, according to an embodiment of the disclosure.

FIGS. 15a and 15b are diagrams illustrating the structure and components of a roller clutch, according to an embodiment of the disclosure.

FIGS. 16a and 16b are diagrams illustrating the structure and components of a brake actuator assembly, according to an embodiment of the disclosure.

FIG. 17 is a block diagram illustrating the exemplary components of a vehicle braking unit, according to an embodiment of the disclosure.

FIG. 18 is a block diagram illustrating the exemplary components of a vehicle braking unit, according to another embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

Vehicles use different braking mechanisms. Frictional brakes are most common today and use friction between two surfaces pressed together to convert the kinetic energy of a moving vehicle into heat, thereby slowing down the vehicle. Electromagnetic brakes are often used where an electric motor is a part of the driving system for a vehicle. Many hybrid and electric vehicles driven by electric motors have regenerative braking which converts energy to electrical energy that can be stored for later use. Other vehicles use induction brakes such as an eddy current brake. An induction brake slows a vehicle by dissipating its kinetic energy as heat. This is achieved by an electromagnetic force between a magnet and a conductive object in relative motion, due to the eddy currents induced in the conductor through electromagnetic induction. Because regenerative braking recovers energy that would be otherwise lost to the brake discs as heat, it is the most efficient braking mechanism for a vehicle. However, regenerative braking is usually not by itself sufficient as the sole means of safely brining a vehicle to a standstill, or slowing it as required, it needs to be used in conjunction with another braking mechanism such as frictional braking.

The present disclosure is generally directed to a braking control method and system for decelerating a vehicle. It is contemplated that the vehicle may be an electric vehicle, a fuel cell vehicle, a hybrid vehicle, or any other types of vehicle that utilizes one or more electric motors as part of its powertrain. The vehicle may have any body style, such as a sports car, a coupe, a sedan, a pick-up truck, a station wagon, a sports utility vehicle (SUV), a minivan, or a conversion van. The vehicle may include a pair of front wheels and a pair of rear wheels (or any other number of wheels). The vehicle may be configured to be all wheel drive (AWD), front wheel drive (FWR), or rear wheel drive (RWD). The vehicle may be configured to be operated by an operator occupying the vehicle, remotely controlled, and/or semi or fully autonomous. For illustrative purpose only, the disclosed method and system will be explained as being implemented to decelerate the vehicle in response to an input by an operator of vehicle (e.g., the operator pressing the brake paddle) or a command by a system of the vehicle without operator input (e.g., the vehicle braking automatically in response to detecting an object in its path). However, it is contemplated that the disclosed method and system can be applied in any scenario that require the engagement of one or more brakes of the vehicle.

More specifically, this disclosure relates to a mutually integrated drive and brake system for an electric motor powered vehicle. Embodiments of the integrated drive and brake system can utilize one or more electric motors of the vehicle to control both the driving and the braking of the vehicle. Individual or multiple brakes can be actuated by one or more electric motors that are part of the vehicle's powertrain unit that is responsible for driving the vehicle. One or more electric motors can actuate brakes on individual wheels to decelerate the vehicle or achieve drive functions such as torque vectoring, electronic stability control (ESC), ABS, and provide drive arrangement flexibility among, for example, FWD, AWD, and RWD.

In some embodiments of the disclosed system, a transmission providing gear reduction can be incorporated after the brake mechanism to amplify the brake torque generated by the brake mechanism. This allows the vehicle to use more compact brake mechanism to achieve the same braking effect as vehicles with larger conventional brake mechanisms. In some embodiments, real-time braking performance feedback can be captured from one or more sensors placed at various locations of the vehicle and used for achieving real-time adjustments to the brake mechanism(s). Because one or more electric motors control the braking mechanism, electrical wire harness and controllers can replace the hydraulic components such as hydraulic lines, valves, brake reservoir and fluids, and brake booster of a traditional hydraulic system used in most vehicles in production today, thereby saving space and reducing overall mass of the vehicle.

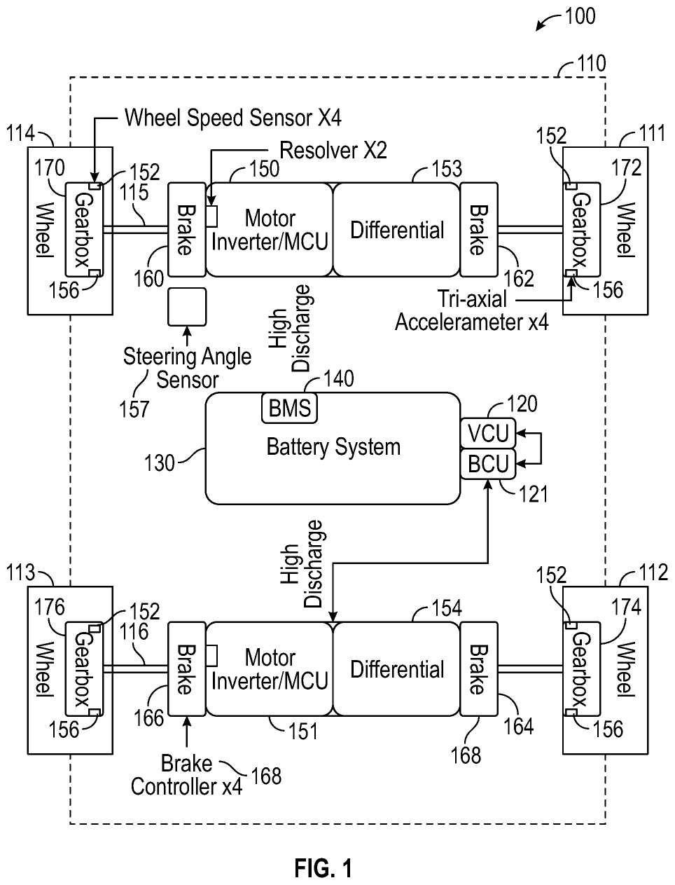

FIG. 1 is a block diagram illustrating the exemplary components of a braking system according to an embodiment of the disclosure. In this embodiment, vehicle 100 can be an electric vehicle. It should be understood that vehicle 100 can also be any other type of vehicles that use electric motor(s) for its drive. As shown in FIG. 1, vehicle 100 may include a chassis 110 and a plurality of wheels 111, 112, 113, 114. Chassis 110 may be mechanically coupled to wheels 111, 112, 113, 114 by, for example, a suspension system (not shown in FIG. 1).

Vehicle 100 may also include an electric or electrical motor mutually integrated drive/braking system (also referred to hereinafter as “drive/braking system” or “integrated braking system”). For example, vehicle 100 may include one or more electric motors to supply motive torque when vehicle 100 is in the drive mode (e.g., when the accelerator pedal is depressed). Each motor may be controlled by a motor control unit (MCU). The MCU may include a DC-AC inverter to convert the DC power supplied by an energy storage device into AC driving power to drive motor. DC-AC invertor may include power electronic devices operating under, for example, a pulse-width modulation (PWM) scheme to convert the DC power into AC power.

Vehicle 100 of FIG. 1 is shown to include two separate electric motors, each with its own MCU and DC-AC inverter. One of the electric motors (together with its MCU and inverter) 150 controls the front wheels 111, 114 during driving and braking. The other electric motor (together with its MCU and inverter) 151 controls the rear wheels 112, 113. Although two electric motors 150, 151 are illustrated in the embodiment of FIG. 1, it should be understood that vehicle 100 can include any number of electric motors. In one embodiment, the vehicle can include a single electric motor. In another embodiment, the vehicle can include a single electric motor for driving and braking the front wheels and two additional electric motors for driving and braking each of the two rear wheels. In yet another embodiment, the vehicle can include two electric motors for controlling the two front wheels and a single additional electric motor for controlling both rear wheels. In yet another embodiment, the vehicle can include four separate electric motors that each controls a separate wheel of the vehicle. Vehicle having more or less than four wheels can have a different number and arrangement of electric motors for implementing embodiments of the disclosure.

In the illustrated embodiment including two electric motors 150, 151, differentials 153, 154 can be coupled to electric motors 150, 151, respectively. Differential 153 can allow the two front wheels 111, 114 to rotate at different rates during driving and/or braking. Similarly, Differential 154 can allow the two rear wheels 112, 113 to rotate at different rates during driving and/or braking. One or both of differentials 153, 154 can be an open differential. As mentioned above, in alternative embodiments, the wheels can be connected to and controlled by separate electric motors.

The MCUs may regulate energy transfer from an energy storage device such as battery system 130 to the motors to drive the motors. In some embodiments, one or more of the motors may operate in a generator mode, such as when vehicle 100 undergoes speed reduction or braking actions. In the generator mode, the excess motion energy may be used to drive the motor(s) to generate electrical energy and feed the energy back to battery system 130 through the MCUs. In some embodiments, battery system 130 may include one or more batteries to supply DC power. Battery system 130 may also be referred to as a battery pack in this document.

As illustrated in FIG. 1, the electric motors 150, 151 may be communicatively coupled to a battery management system (BMS) 140. BMS 140 can be associated with the battery system 130 and configured to manage the usage and charging of the battery system 130 in a safe and reliable manner. In particular, BMS 140 may constantly monitor the State-of-charge (SoC) of the battery pack. For example, BMS 140 may monitor the output voltage of the battery pack, voltages of individual cells in the battery pack, current in and/or out of the battery pack, etc. BMS 140 may send information regarding the SoC to the MCUs for further processing. In some embodiments, BMS 140 may also be configured to monitor the state of health (SoH) of the battery pack, including the battery temperature.

Vehicle 100 may include a vehicle control unit (VCU) 120 to provide overall control of vehicle 100. For example, VCU120 may act as an interface between user operation and drive system reaction. For example, when a driver depresses an acceleration pedal (not shown in FIG. 1) of vehicle 100, VCU 120 may translate the acceleration operation into a torque value to be output by motors 150, 151, a target rotation speed of motors 150, 151, or other similar parameters to be executed by the integrated drive/brake system. VCU 120 may be communicatively connected to MCUs 150, 151 to supply commands and/or receive feedback. Additionally, VCU 120 may be communicatively connected to battery system 130 to monitor operation status such as energy level, temperature, recharge count, etc. Additionally, VCU 120 may be communicatively connected to one or more sensors of vehicle 100 to receive information regarding the vehicle. Exemplary sensors are discussed below.

Unlike existing vehicles that use a traditional hydraulic braking system, vehicle 100 of FIG. 1 uses the electric motor(s) to provide braking for the vehicle, which essentially replaces the hydraulic components in a traditional hydraulic braking system with wire harness and controllers.

Specifically, as illustrated in FIG. 1, vehicle 100 may also include a brake control unit (BCU) 121 to provide control of vehicle's braking function. In one example, the BCU 121 can be connected to a brake pedal (not shown in FIG. 1) of vehicle 100. BCU 121 can also be communicatively connected to electric motors and MCUs 150, 151 to supply commands and/or receive feedback. When a driver depresses the brake pedal, BCU 121 may translate the braking operation into a torque value to be output by electric motors 150, 151, a target rotation speed of motor 150, 151, or other similar parameters to be executed by the integrated drive/brake system. BCU 121 may also be communicatively connected to VCU 120 for receiving various vehicle data that may contribute to the BCU's braking control functions. In some embodiments, BCU 121 can be part of the VCU 120.

In operation, BCU 121 may monitor the state of vehicle 100 in order to be able to preciously control the generation of proper amounts of braking torques and/or distribution of the braking torques among wheels 111, 112, 113, 114. The state of vehicle 100 can be determined from information received from the various sensors of vehicle 100, each of these sensors configured to detect the operation and/or motion state of vehicle 100.

For example, vehicle 100 may include one or more wheel speed sensors (collectively as 152) attached to one or more wheels 111, 112, 113, 114 for detecting the rotational speed of the corresponding wheel. Additionally or alternatively, vehicle 100 may also include one or more accelerometers (collectively as 156) configured to determine the linear acceleration of vehicle 100 in a particular direction. In the illustrated embodiment, the one or more accelerometers can be tri-axial accelerometers 156 capable of determining the linear acceleration of vehicle 100 in three (i.e., the x, y, and z) different directions.

Additionally or alternatively, vehicle 100 may also include a steering angle sensor 157 configured to detect the angle of the steering wheel (part of steering system, not shown in FIG. 1) as measured from a neutral position indicating that front wheels 111, 114 are parallel and pointing straight forward. Additionally or alternatively, vehicle 100 may also include sensors not illustrated in FIG. 1, including, for example: a suspension sensor configured to detect the linear movement of the body of vehicle 100 in a vertical direction; a yaw sensor configured to determine the orientation of the chassis 110 with respect to the direction of travel; an angular rate gyro configured to measure the yaw rate of vehicle 100; and/or a weight sensor configured to detect the weight of vehicle 100 and/or the distribution of the weight over the axles/wheels.

In some embodiments, various sensors measuring the deceleration/acceleration and angular rates of vehicle 100 may be integrated in an inertial measurement unit (IMU). For example, the IMU may be a 6-degree of freedom (6 DOF) IMU, which consists of a 3-axis accelerometer, 3-axis angular rate gyros, and sometimes a 2-axis inclinometer. The 3-axis angular rate gyros may provide signals indicative of the pitch rate, yaw rate, and roll rate of vehicle 100. The 3-axis accelerometer may provide signals indicative of the acceleration of vehicle 10 in the x, y, and z directions. The brake pedal and accelerator pedal (not shown in FIG. 1) can also be considered sensors of vehicle 100.

In addition to the exemplary sensors discussed above, vehicle 100 may also include one or more of cameras, LIDARs, radars, proximity sensors, ultrasound sensors that can provide input to initiate braking when vehicle 100 is in semi or full autonomous mode. In some embodiments, BCU 121 can receive information detected by the one or more sensors of the vehicle through the VCU 120. In other embodiments, BCU 121 can receive information directly from the one or more of these sensors.

In some embodiments, BCU 121 can also receive braking performance feedback from one or more sensors and adjust the braking output to each wheel according to the feedback.

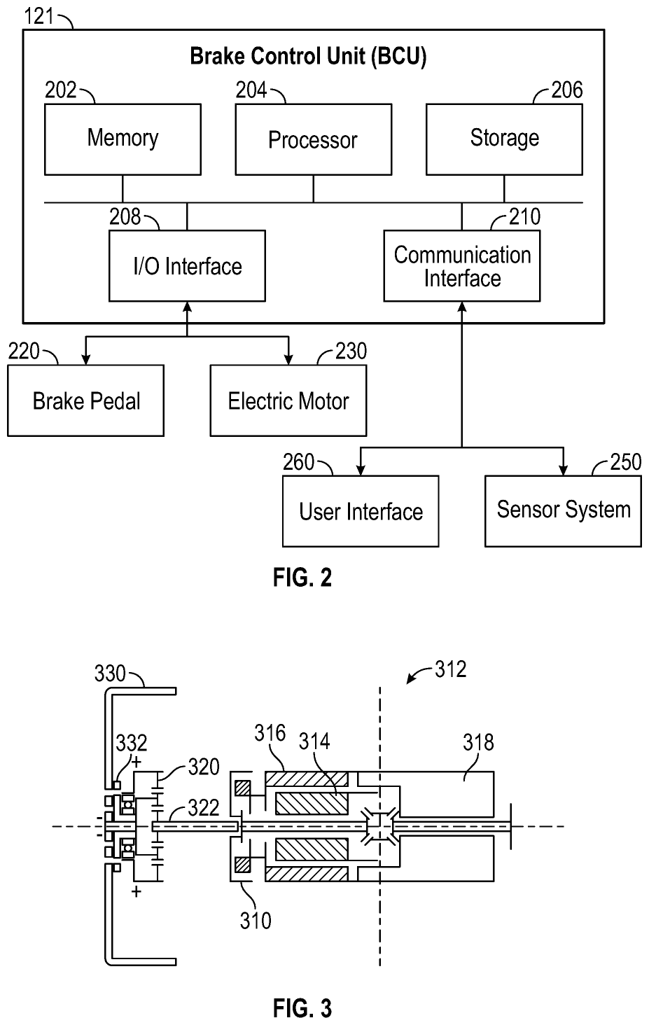

FIG. 2 illustrates exemplary components of BCU 121. BCU 121 may include one or more of the following components: a memory 202, a processor 104, a storage 206, an input/output (I/O) interface 208, and a communication interface 210. In some embodiments, BCU 121 may be implanted as part or whole of an electronic control module (ECM). At least some of these components of BCU 121 may be configured to transfer data and send or receive instructions between or among each other. Exemplary structures and functions of the components are outlined below.

Processor 204 may include any appropriate type of general-purpose or special-purpose microprocessor, digital signal processor, or microcontroller. Processor 204 may be configured as a separate processor module dedicated to control and actuate braking system of the vehicle. Alternatively, processor 204 may be configured as a shared processor module for performing other functions unrelated to operating the braking system.

Processor 204 may be configured to receive data and/or signals from various components (e.g., sensors) of the vehicle and process the data and/or signals to determine one or more conditions of the vehicle. For example, processor 204 may receive the signal generated by brake pedal 220 via, for example, I/O interface 108. As described in more detail below, processor 204 may also receive information regarding the motion and/or operation status of the vehicle from sensory system 250 via, for example, communication interface 210. Sensory system 250 of FIG. 2 may include one or more sensors (e.g., wheel speed sensors 152, tri-axial accelerometers 156, steering angle sensor 157) discussed above with reference to FIG. 1. Processor 204 may further generate and transmit a control signal for actuating one or more components of braking system, such as electric motor 230 and associated power electronics. Electric motor 230 of FIG. 2 can be one of the electric motors 150, 151 of FIG. 1.

Processor 204 may execute computer instructions (program codes) stored in memory 202 and/or storage 206, and may perform functions in accordance with exemplary techniques described in this disclosure. Memory 202 and storage 206 may include any appropriate type of mass storage provided to store any type of information that processor 204 may need to operate. Memory 202 and storage 206 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 202 and/or storage 206 may be configured to store one or more computer programs that may be executed by processor 204 to perform exemplary braking control functions disclosed in this disclosure. For example, memory 202 and/or storage 206 may be configured to store program(s) that may be executed by processor 204 to determine the amount of brake torque required when brake pedal 220 is depressed. The program(s) may also be executed by processor 204 to generate a proper amount of braking based on the input received by the BCU 204.

In some embodiments, processor 204 may control electric motors 230 to enter into a generator mode. As the back electromotive force in electric motors 230 builds up, the motor current may quickly reverse direction and start to charge the battery pack (not shown in FIG. 2), so as to generate the regenerative braking torques. Moreover, processor 204 may execute the program(s) to adjust the current limit of the powertrain based on the deceleration of the vehicle, so as to adjust the amount of regenerative braking accordingly.

Memory 202 and/or storage 206 may be further configured to store information and data used by processor 204. Memory 202 and/or storage 206 may be configured to store one or more functions specifying the desired amount of braking and various data concerning the status of the vehicle. For example, memory 202 may maintain a predetermined corresponding relationship between the position and/or the amount of depression of the brake pedal and a target deceleration of vehicle 10. This way, the braking system may create a consistent driving experience for the operator. It is contemplated that the relationship between the position and/or the amount of depression of the brake pedal 120 and the deceleration of vehicle 10 may be linear or non-linear. In some embodiments, memory 202 and/or storage 206 may also store the sensor data generated by sensor system 250, which may be further processed by processor 204.

I/O interface 208 may be configured to facilitate the communication between BCU 121 and other components of the integrated drive/braking system. For example, I/O interface 208 may receive a signal generated by braking pedal 220, and transmits the signal to processor 204 for further processing. I/O interface 208 may also output commands to electric motors 230 or other components of the powertrain (e.g., power electronics) for adjusting the magnitudes of braking torques and/or distribution of the braking torques among the wheels (not shown in FIG. 2).

Communication interface 210 may be further configured to communicate with sensor system 250 and/or user interface 260, via a wired or wireless connection configured for transmitting and receiving data. For example, the connection may be a wired network, a local wireless network (e.g., Bluetooth™, WiFi, near field communications (NFC), etc.), a cellular network, an Internet, or the like, or a combination thereof. Other known communication methods, which provide a medium for transmitting data are also contemplated.

User interface 260 can be any interface that allows a user (e.g., operator, occupant) of the vehicle to send command to the BCU 121. For example, user interface 260 can be an emergency brake button that can be operated by the user, a button to switch the vehicle to a semi or full autonomous mode, or a button to switch the vehicle from two-wheel drive to four-wheel drive mode. Any user input received via user interface 260 can be routed for processing by BCU 121.

Referring back to FIG. 1, wheels 111, 112, 113, 114 may be coupled to the one or more electric motors in various ways. As illustrated in FIG. 1, each wheel may be connected to one of the electric motors through a shaft and a differential. For example, wheel 114 is connected to electric motor 150 through shaft 115 and differential 153, which transmits torque from motor 150 to wheel 114. Similarly, wheel 113 is connected to electric motor 151 through shaft 116 and differential 154, which transmits torque from motor 151 to wheel 113. Other wheels can be connected to the electric motor(s) and operate in a similar fashion. In the embodiment of FIG. 1, two opposite wheels (e.g., front wheels 111, 114) can be driven by the same motor 150. Similarly, the other pair of opposite wheels (rear wheels 112, 113) can be driven by a second motor 151 of the vehicle 110. The differentials 153, 154 can be open differentials that allow the opposite wheels to be controlled individually. This allows the wheels to receive a different amount of motive and/or brake torque. In an alternative embodiment, opposite wheels can be driven by different motors to achieve the same results. In yet another embodiment, multiple motors may be used and each wheel may be driven by a group of motors. In still yet another embodiment, motor may be built into a wheel such that the wheel may rotate co-axially with a rotor of the motor.

In some embodiments, vehicle 100 can be switched among the AWD, FWD, and/or RWD modes, as needed. For example, vehicle 100 may be initially in the FWD mode, with front wheels 114, 111 being driven and braked by one or more electric motors 150. When vehicle 100 is commanded to switch to the AWD mode, powertrain controller 100 may engage an additional electric motor 151, to the rear axle, such that rear wheels 14 may also be driven and braked by electric motors 151. As such, BCU 121 may control when certain wheels can be applied with the braking torque. In some embodiments, BCU 121 may also individually control the different electric motors 150, 151 to not only adjust the magnitude of torque but also the direction of the torque (i.e., traction or braking) on each wheel.

In the embodiment illustrated in FIG. 1, each of brake mechanisms 160, 162, 164, 166 for the corresponding wheels 114, 111, 112, 113 can be connected to one of the electric motors 150, 151. When braking, BCU 121 can send commands to one or more of the electric motors 150, 151 to generate brake torque through the one or more brake mechanisms 160, 162, 164, 166. In this embodiment, each brake mechanism 160, 162, 164, 166 may also be associated with a brake controller (collectively as 168). The brake controllers can be in communication with the BCU and configured to combine different types of braking forces to produce the optimal braking effect for the corresponding wheel.

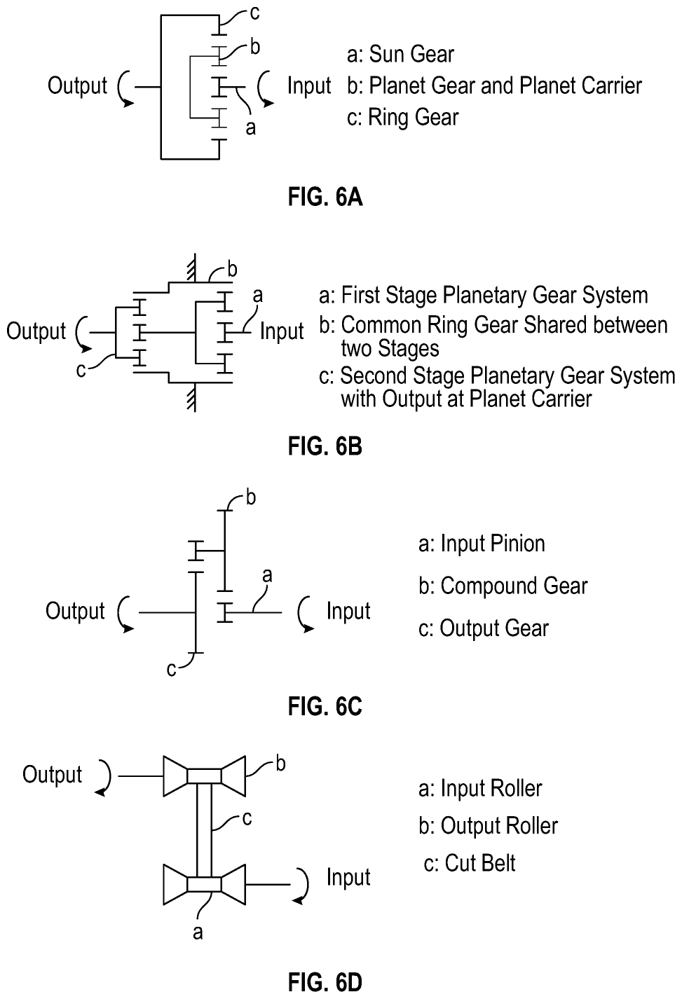

As illustrated in FIG. 1, each brake mechanism 160, 162, 164, 166 can be connected to a corresponding transmission (or gearbox) 170, 172, 174, 176. In other words, the brake mechanisms are arranged before the transmission 170, 172, 174, 176. The transmissions 170, 172, 174, 176 can amplify the brake torque generated by the brake mechanisms 160. 162, 164, 166 through gear reduction or any other suitable means. The transmission can be any type of transmission including but not limited to single stage planetary gear reduction (FIG. 6a), multi-stage planetary gear reduction (FIG. 6b), spur/helix gear reduction (FIG. 6c), and CVT transmission (FIG. 6d). This allows the vehicle to be equipped relatively small brake mechanisms to generate at least the same amount of brake torque that a larger brake mechanism could, thereby saving space and reducing the weight of the vehicle.

FIG. 3 provides an enlarged view of the exemplary components of the brake mechanism of one of the wheels 330 of vehicle 100. The brake mechanism 310 can be connected to an electric motor 312. The motor 312 can be an AC synchronous electric motor including a rotor 314 and a stator 316. The stator 316 may include a plurality of poles (not shown in FIG. 3), with each pole including windings connected to an AC power source, such as a three-phase AC power source. In this embodiment, the AC power source can be the output of a DC-AC inverter 318. During operation, the AC powered stator 316 may generate a rotating magnetic field to drive the rotor 314 to rotate. The rotor 314 may include windings and/or permanent magnet(s) to form a magnet such that the north/south pole of the magnet is continuously attracted by the south/north pole of the rotating magnetic field generated by the stator 316, thereby rotating synchronously with the rotating magnetic field. Exemplary AC synchronous electric motors include interior permanent magnet (IPM) motors, reluctance motors, and hysteresis motors. It should be understood that other types of electric motors can also be used to provide the same functions.

Referring again to FIG. 3, the brake mechanism 310 can be connected to the electric motor 312 on one end and a transmission 320 on the other end. The brake mechanism 310 can generate brake torque from the output of the electric motor 312 and pass the brake torque to the transmission 320 through a connection such as shaft 322 connecting the brake mechanism 310 and the transmission 320. In the illustrated embodiment, the transmission 320 can be attached to the wheel 330 and, through gear reduction, amplify the brake torque transmitted over the shaft 322 to produce the desired braking effect on wheel 330. The transmission 320 can be built-in the wheel 330 as illustrated in FIG. 3 or external to the wheel and connected to wheel bearing 332 of the wheel 330 by any suitable means. In one embodiment, transmission 320 can be in adjacent to the brake mechanism 310. All four wheels of the vehicle can have the same braking system of FIG. 3, which includes the electric motor 312, inverter 318, brake mechanism 310, transmission 320 and wheel assembly 330. In some embodiments, a single electric motor and inventor can generate brake torque for multiple wheels of a vehicle. For example, as illustrated in FIG. 1, electric motor and inverter combination 150 can generate braking torque for brake mechanisms 160, 162 for front wheels 114, 111, respectively, through open differential 153. Similarly, electric motor and inventor combination 151 can generate braking torque for brake mechanism 166, 164 for rear wheels 113, 112, respectively, through open differential 154.

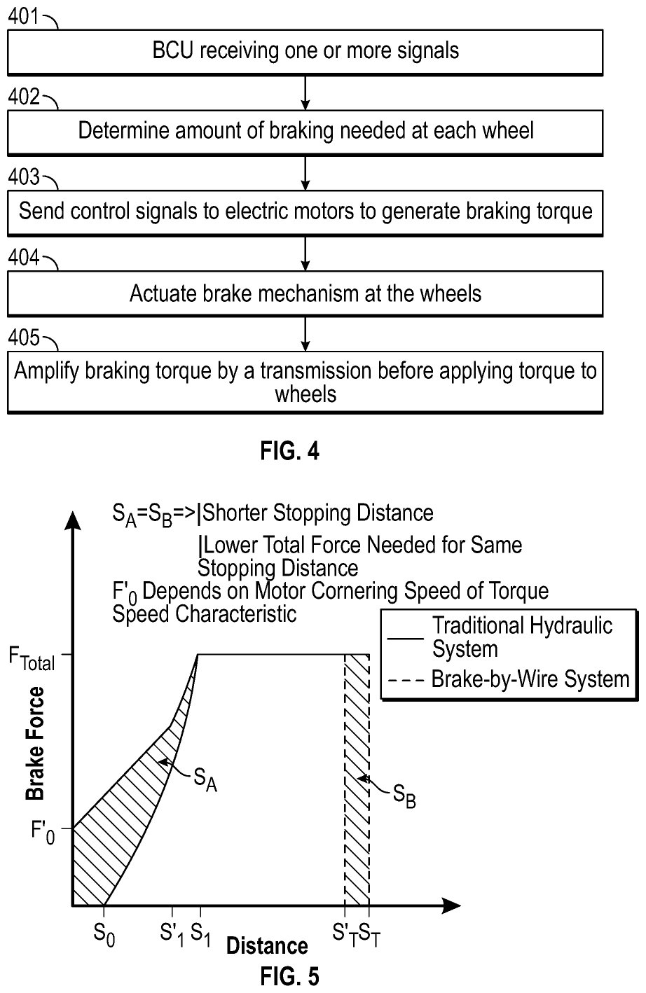

FIG. 4 is a flow chart illustrating the exemplary steps in the operation of the braking system of FIGS. 1-3. First, one or more signals are received by the BCU indicating that the brake(s) for one or more of the wheels need to be engaged (step 401). The signal(s) can come from the brake pedal of the vehicle via an I/O interface of the BCU. Alternatively, the signal can be received by the BCU in response to an input via a user interface of the vehicle. Alternatively, the brake signal can be generated by an in-vehicle system such as an autonomous driving system of the vehicle in response to information collected from one or more sensors of the vehicle that indicates a need to engage the brakes.

In response to receiving the brake signal, BCU can determine the amount of braking needed in terms of, for example, the amount of brake torque that needs to be generated at each wheel (step 402). Various data are required for the BCU to make this determination depending on the information received. For example, if the signal is from the brake pedal, BCU can determine the amount of brake torque and/or the direction of the torque from, among other things, the force applied to the brake pedal and the speed in which the force is applied. As another example, if the signal is from the autonomous system, BCU can determine the amount of brake torque based, for example, on the speed of the vehicle and the distance between the vehicle and an object in the path of the vehicle. In some embodiments, BCU can calculate different amounts of braking torques for different wheels to create torque vectoring. The amount of braking torque calculated by BCU can take into account the torque amplifying effect that can be produced by the transmission(s) (e.g., transmission 320 in FIG. 3) connected to the braking mechanism.

After BCU determines the amount of braking torque needed at each wheel, BCU can send control signals to the one or more electric motors of the vehicle to generate the braking torque (step 403). The electric motor(s) can then actuate the brake mechanisms at one or more of the wheels accordingly (step 404). The generated braking torque can then be amplified by a transmission before being applied to the corresponding wheel (step 405).

FIG. 5 is a diagram comparing braking performance between the braking system disclosed in the embodiments above and a traditional hydraulic system. As shown in the figure, the braking system of the disclosed embodiments can achieve shorter shopping distance (S_{T}′) than the hydraulic system (S_{T}). Alternatively, the braking system of the disclosed embodiments can achieve the same stopping distance using a lower total force than the traditional hydraulic system, as illustrated in FIG. 5.

Overall, the integrated drive/brake systems and methods of the disclosed embodiments can replace the conventional hydraulic system. Because fewer parts are required and the size of the brake mechanisms can be reduced by incorporating transmissions that amplifies braking effect in the system without sacrificing brake performance, the disclosed embodiments can take less space and save overall mass of the vehicle, thereby reducing cost of the vehicle. The integrated drive/brake system can also provide drive arrangement flexibility among FWD, AWD, and RWD and fully replace existing hydraulic brake system, ESC, and ABS. Furthermore, because the disclosed embodiments are fully digitized systems using electrical control rather than analog controls, it can be easily integrated with other digital system such as semi or full autonomous systems of the vehicle.

In another aspect of the disclosure, a braking system using a combination of regenerative braking, frictional braking, and/or induction braking in disclosed. Also disclosed in a correlating brake blending mechanism that can maximize brake system performance, reduce friction brake system wear and minimize thermal impact on the brake system.

In one embodiment, when the one or more electric motors of the vehicle are running at low revolutions per minute (RPM), typically when the vehicle is in slow speed, regenerative braking may not be sufficient or efficient to slow down or stop the vehicle on its own, especially if sudden deceleration is needed in response to a driver input or a signal from an autonomous braking system of the vehicle. To ensure that enough braking force can be generated in response to the driver's input or the signal from the vehicle's automated braking system, the vehicle's friction brakes can be engaged to supplement regenerative braking. Additionally, induction brakes (i.e., eddy current brakes) can also be engaged to enhance the overall braking effect.

To minimize the wear on the friction brakes (e.g., the brake pads and rotors) as well as reduce the effect of temperature rise to the brake system, the disclosed brake blending mechanism can cut off frictional braking when sufficient braking effect can be achieved by regenerative braking alone or a combination of regenerative braking and induction braking. This typically occurs at or around a certain RPM of the electric motor(s) where the effect of induction braking reaches a certain threshold and the combined braking effect of the regenerative brake and induction brakes is sufficient to achieve the desired braking effect on the vehicle.

As the braking torque generated by the induction brakes levels off at or near its peak as the RPM of the electric motor(s) continues to increase, the effect of regenerative braking can begin to tail off. Thus, at the higher RPM range, the braking of the vehicle relies primarily on the induction brakes instead of regenerative braking. The friction brakes can remain disengaged.

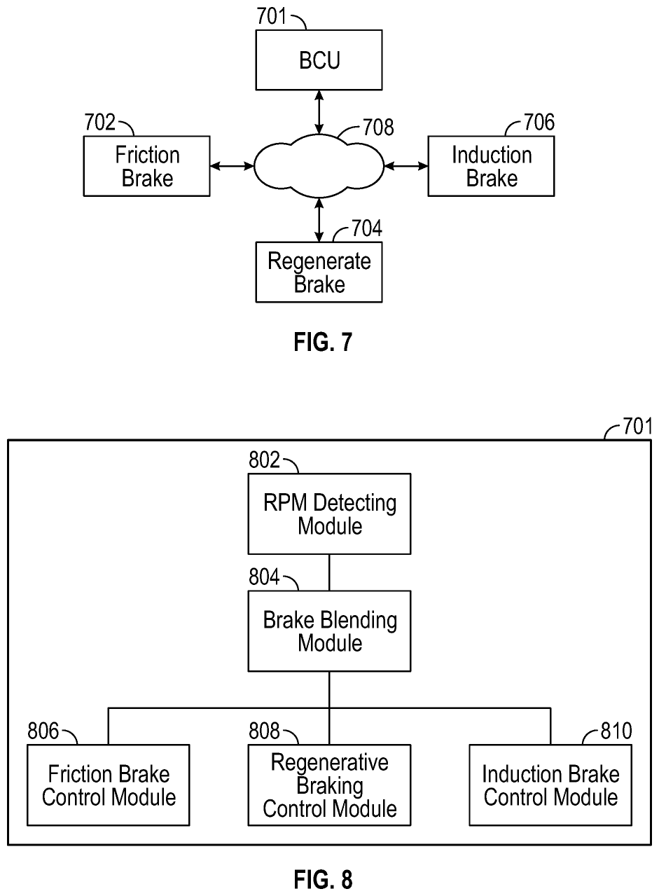

FIG. 7 is a block diagram illustrating the exemplary components of a braking system 700. The braking system can include one or more friction brakes (collectively referred to as 702), regenerative braking system 704, and one or more induction brakes (collectively referred to as 706). The friction brake(s) 702, regenerative braking system 704, and induction brake(s) 706 can be connected to and controlled by a BCU 701 via a network 708. Each of the friction brake(s) 702, regenerative braking system 704, and induction brake(s) 706 can operate independently or in combination to slow down and stop the vehicle. The mechanisms of how each of these three types of brakes operates is well known and thus not explained in detail in this document.

The BCU 701 can have the same or similar exemplary components of BCU 121 of FIG. 2. For example, BCU 701 can include a memory (not explicitly shown in FIG. 7) that includes various modules that have designated functions in the brake control operation. FIG. 8 is a block diagram illustrating the exemplary modules stored in BCU 701. In this example, the BCU 701 includes an RPM detecting module 802, a brake blending module 804, a friction brake control module 806, a regenerative brake control module 808, and an induction brake control module 810. The RPM detecting module 802 can monitor and/or detect a RPM of the one or more electric motors of the vehicle in real time. The RPM of the electric motor(s) can correlate to the power output of the motor(s). The brake blending module 804 can determine, based on the detected RPM of the motor(s), a desired braking torque contribution from each of the braking mechanisms of the vehicle (namely, regenerative braking, frictional braking, and induction braking), based on a predetermined brake blending strategy.

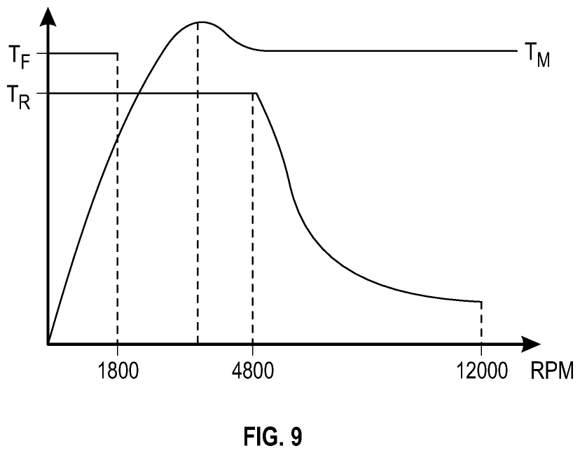

An exemplary brake blending strategy can be reflected by the correlation between the motor operating RPM and brake torque from each of the three braking mechanisms, as illustrated in the graph of FIG. 9. The brake blending strategy of FIG. 9 is designed to maximize the braking torque output from regenerative braking. Because regenerative braking allows energy generated from braking to be captured, stored, and reused by the powertrain of the vehicle, it is the preferred braking mechanism over frictional braking and induction braking, neither of which can offer the same benefit.

As illustrated in the graph of FIG. 9, braking torque from regenerative braking (T_{R}) peaks at low RPM. T remains at or near its peak at low RPM and drops off when the RPM reaches about 4800. It should be understand that the RPM at which the drop-off occurs for regenerative braking torque can vary depending, for example, on the type of electric motor(s) equipped in the vehicle and their output. Under most circumstances, the braking torque (T_{R}) from regenerative braking is, on it own, not sufficient to produce all the required stopping force to slow down or stop the vehicle. Accordingly, as illustrated in FIG. 9, additional braking torques generated by the frictional brake(s) and/or induction brake(s) can supplement the braking torque from regenerative braking to achieve the desired braking effect.

Braking torque generated by the friction brake(s) (T_{F}) can be sized to maximum system capacity for redundancy and safety because friction brakes are, by comparison, the most reliable type of brakes on the vehicle. However, if the friction brake(s) are the relied upon as the primary braking mechanism, it will wear out more quickly and its performance degraded at a faster rate than if it is used as a secondary braking mechanism, such as in the embodiments disclosed herein. According to the brake blending strategy shown in FIG. 9, the friction brake(s) can generate maximum braking torque at low RPM to ensure that the vehicle can stop properly at low speed or when its parking brake is engaged. The friction brake(s) can be disengaged at a certain critical RPM (e.g., 1800 as shown in FIG. 9) to limit the wear on the friction material in the friction brakes, thereby allowing them to operate at a high performance level for an extended period of time. It should be understood that the RPM at which the friction brake(s) are to be disengaged can vary based on the type of friction brake(s) used in the vehicle and a determination as to whether frictional braking is required to ensure safe stopping of the vehicle when the electric motor(s) are operating at a particular RPM. For example, the critical friction brake(s) can be set higher than 1800 if the other braking mechanisms (e.g., regenerative braking) are unable to produce the necessary braking torque at 1800 RPM.

When the friction brake(s) are disengaged at the critical RPM (e.g., 1800 as shown in FIG. 8), regenerative braking may still not be sufficient on its own to produce enough braking torque. This can be resolved by using the induction brake(s) of the vehicle to supplement regenerative braking. As shown in the graph of FIG. 8, the braking torque profile of the induction brake(s) (Tₘ) can be sufficiently close to its peak when the electric motor(s) are running at about 1800 RPM (i.e., when the friction brake(s) are disengaged). As the RPM of the motor(s) increases, the braking torque (Tₘ) generated by the induction brake(s) will stabilize, as shown in FIG. 8. In this embodiment, after the RPM reaches about 4800, braking torque (T_{R}) from regenerative braking will decline as the motor(s) operate in a constant power region. Thus, at above 4800, the induction brake(s) essentially becomes the primary braking mechanism for the vehicle with friction brake(s) remain disengaged. It should be understood that the RPM threshold at which regenerative braking starts to decline and induction brake(s) take over as the primary braking mechanism is not necessary 4800. It can be at a different RPM depending on the type of motor used, motor control algorithms, and other factors.

In general, the brake blending mechanism disclosed in the above embodiment maximizes the use of regenerative braking and supplements regenerative braking with friction brake(s) and/or induction brake(s) when needed. The formula below reflects the correlations among the contributions from the three different types of braking mechanisms:

T_{B}−T_{R}=T_{F}+T_{M}

Where T_{B} is the total braking torque required; T_{R} if the amount of braking torque generated from regenerative braking, which is to be maximized under at all RPM of the motor(s); T_{F} is the amount of braking torque generated from the friction brake(s); and T_{M} is the amount of braking torque generated from the induction brake(s).

Referring again to FIG. 8, after the brake blending module 804 receives the RPM from the RPM detecting module 804. It can determine a contribution of the braking torque from each of the three types of brakes, namely, the friction brake(s), regenerative brake, and inductive brake(s), based on a predetermined brake blending strategy such as the one shown in FIG. 9. The brake blending module 804 can then determine whether or not each of the three braking mechanisms needs to be engaged or disengaged. Based on that determination, the brake blending module 804 can send separate instructions to the friction brake control module 806, the regenerative braking control module 808, and the induction brake control module 810 to facilitate braking of the vehicle. The friction brake control module 806, the regenerative braking control module 808, and the induction brake control module 810 control the friction brake(s), the regenerative braking, and the induction brake(s) of the vehicle, respectively.

For example, if the RPM detecting module 802 detects the RPM of the motors to be at 1000. The brake blending module 804 can determine that all three types of brakes need to be activated, based on the graph of FIG. 9, with the friction brake(s) generating the most braking torque. In another example, if the RPM detecting module 802 detects the RPM of the motors to be at 3000, the brake blending module 804 can apply only the regenerative braking and the induction brakes, with the regenerative braking at its maximum capacity. In yet another example, if the RPM detecting module 802 detects the RPM of the motors to be at 10000, the brake blending module 804 can still apply the regenerative braking and the induction brakes. However, because the braking torque from regenerative braking at 10000 RPM is relative small, the induction brake(s) can provide most of the required braking torque.

Referring back to FIG. 1, as previously discussed, wheels 111, 112, 113, 114 may be coupled to the one or more electric motors in various ways. As illustrated in FIG. 1, each wheel may be connected to one of the electric motors through a shaft and a differential. For example, wheel 114 is connected to electric motor 150 through shaft 115 and differential 153, which transmits torque from motor 150 to wheel 114. Similarly, wheel 113 is connected to electric motor 151 through shaft 116 and differential 154, which transmits torque from motor 151 to wheel 113. Other wheels can be connected to the electric motor(s) and operate in a similar fashion. In the embodiment of FIG. 1, two opposite wheels (e.g., front wheels 111, 114) can be driven by the same motor 150. Similarly, the other pair of opposite wheels (rear wheels 112, 113) can be driven by a second motor 151 of the vehicle 110. The differentials 153, 154 can be open differentials that allow the opposite wheels to be controlled individually. This allows the wheels to receive a different amount of motive and/or brake torque.

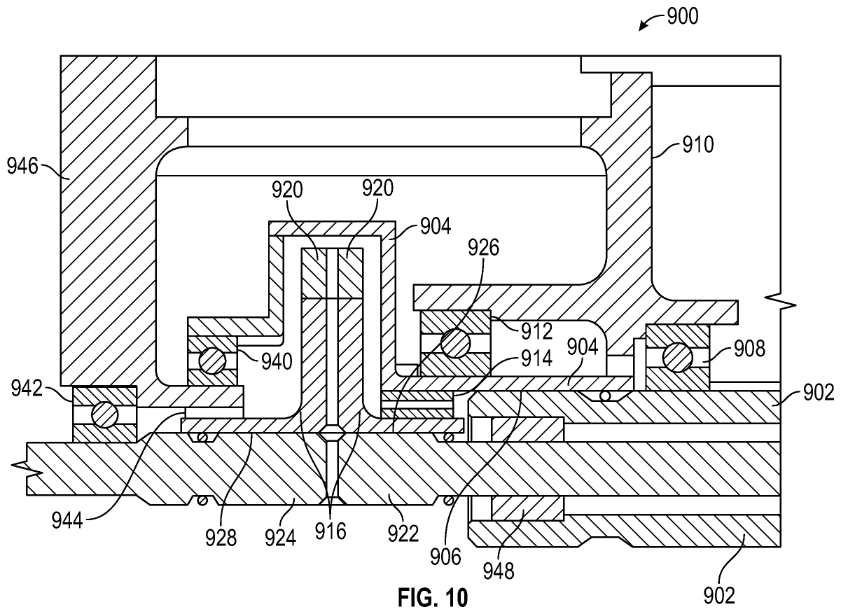

FIG. 10 illustrates an exemplary structure of a differential 900 (e.g., differential 153 or 154 of FIG. 1). The differential 900 can connect a motor (not fully shown in FIG. 10) to two different driving shafts (i.e., right driving shaft 922 and left driving shaft 924) to provide torque to the wheels connected to these driving shafts 922 and 924. More specifically, as illustrated in FIG. 10, the motor shaft 902 can be coupled through the differential housing 904 to a pair of planet gears 920, which can in turn each be couple to a sun gear (collectively 916). Each of the sun gears 916 can be coupled to a respective driving shaft 922, 924. As illustrated in FIG. 10, the sun gear on the right is coupled to the right driving shaft 922 and the sun gear on the left is coupled to the left driving shaft 924. Each of the driving shafts 922 and 924 can be driven, separately or together, by the motor shaft 902 through the differential 900, specifically, through the respective set of planet gear 920 and sun gear 916. The differential 900 can allow the two driving shafts 922, 924 to receive different amounts of torque and, thus, rotate at different speed.

To reduce the space and parts required to couple the differential 900 to the motor and the driving shaft, a number of splines and bearings can be positioned in specific locations between two or more components. As illustrated in FIG. 10, a first spline 906 can mate the motor shaft 902 with the differential housing 904 and transfer torque from the motor shaft 902 to the differential gears. A second spline 926 can mate one of the sun gears 916 with the corresponding right driving shaft 922. A third spline 928 can mate the other sun gear 916 with its corresponding left driving shaft 924. The second and third splines 926, 928 can transfer torque from each of the sun gears 916 to the respective driving shaft 922, 924. The illustrated use of the splines can provide a tight coupling of the various components of the motor, differential, and the driving shafts. It can eliminate the needs to use additional parts or other bulkier parts to achieve the same purpose.

In addition, a first ball bearing 908 can be positioned between the motor shaft 902 and the motor housing 910 to allow the motor housing 910 to provide support for the motor shaft 902 and, additionally, the right driving shaft 922. A second ball bearing 912 can be positioned between the differential housing 904 and another part of the motor housing 910 to provide support for the differential housing 904 and planet gears 920 which are mounted on differential housing904. A third ball bearing 940 can be placed between the differential housing 904 and the inverter housing 946 to provide another side support for the differential housing 904 and planet gears 920. A fourth ball bearing 942 can be position between the left driving shaft 924 and the inverter housing 946 to provide support for the left driving shaft 924.

Additionally, the differential can also include a number of needle bearings to provide support to the sun gears 916 and the driving shafts 922. As shown in FIG. 10, a first needle bearing 914 can be positioned between the differential housing 904 and the sun gear 916 of the differential 900. A second needle bearing 944 can be positioned between the inverter housing 946 and the other sun gear 916 of the differential 900. The first and second needle bearings 914, 944 can provide support for the right and left sun gear, respectively. A third needle bearing 948 can be positioned at the internal surface of the motor shaft 902 to provide support for the right driving shaft 922. In one embodiment, the right driving shaft can be connected to another end of motor housing (not shown in FIG. 10) and a braking system discussed above (also not shown in FIG. 10).

It should be understood that one or more of these bears 908, 912, 940, 942, 914, 944, 948 may be optional or replaced by other mechanical components that provide similar functions. It should also be understood that the bearings 908, 912, 940, 942, 914, 944, 948 may be positioned at different locations in the additional types of bearings may be used.

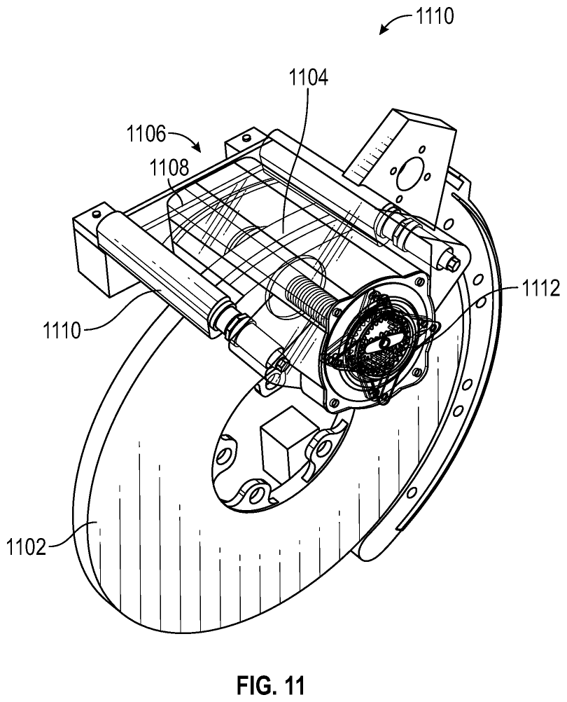

In another aspect, the present disclosure is directed a friction brake. For example, the friction brake can be the brake mechanism 310 of FIG. 3 and/or the Friction Brake 702 of FIG. 7. As illustrated in FIG. 7, the friction brake can be controlled by BCU 701 according to the brake blending method disclosed above, with reference to FIGS. 8 and 9. A 3-dimensional prospective view of an exemplary friction brake device according to an embodiment of this disclosure is provided in FIG. 11. The friction brake device 1100 includes a brake rotor 1102, brake pads 1104, brake caliper 1106 including caliper body 1108 and caliper bracket 1110. In the friction brake device 1100, brake caliper 1106 can squeeze the brake pads 1104 against the surface of the brake rotor 1102 and the resulting friction force slows down the rotation of the wheel housing the friction brake device 1110. The same friction brake device 1110 can be used in each wheel of a vehicle. The combined braking force generated by one or more of the friction brake devices 1110 can slow or stop the vehicle.

In this embodiment, the friction brake device 1110 can be controlled (e.g., engaged and disengaged) by an electric motor. As illustrated in FIG. 11, the friction brake device 1110 can further include a brake transmission 1112 that, when driven by an electric motor (not shown in FIG. 11), converts the power generated by the electric motor into braking torque that is applied by the braking pads 1104 on the brake rotor 1102.

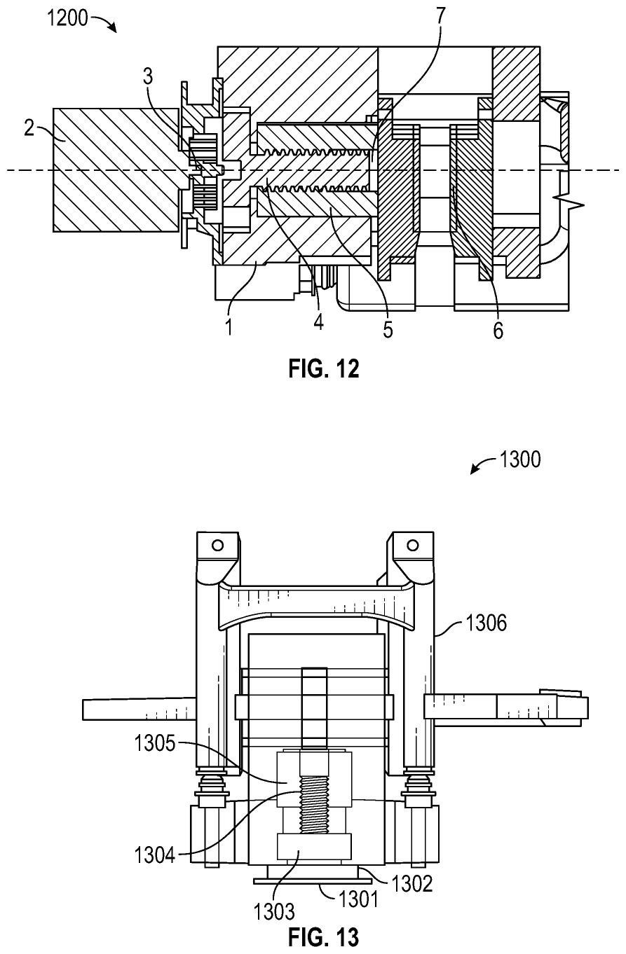

FIG. 12 provides a side view of a braking system of a vehicle, according to an embodiment of the present disclosure. The braking system 1200 includes an electric motor 2, a transmission and roller clutch (collectively 3), a lead screw 4, a piston 5, a caliber body 1, and brake pads 6. The rotor of the electric motor 2 can be connected to the transmission and roller clutch assembly 3. The transmission can be a planetary transmission or any other transmission that's suitable for the illustrated embodiment. Through the transmission and roller clutch assembly 3, the torque generated by the electric motor 2 can drive the lead screw 4 into a center hole 7 of the piston 5. This, in turn, can generate a force that pushes the piston 5 into the brake pads 6, engaging the friction brake to slow and/or stop the rotation of the wheel (not shown in FIG. 12). The lead screw 4 can be an ACME 5/8-8 screw or any other suitable screws.

FIG. 13 provides a top view of the braking system of FIG. 12. In this view, the braking system 1300 includes a motor 1301 (not fully shown) capable of producing braking torque, a planetary transmission 1302 and a roller clutch 1303 sandwiched between the motor 1301 and the friction brake 1306. The planetary transmission 1302 and the roller clutch 1303 can transfer the braking torque generated by the motor 1301 via a lead screw 1304 and piston 1305 to the brake pads (not fully shown) in the friction brake 1306.

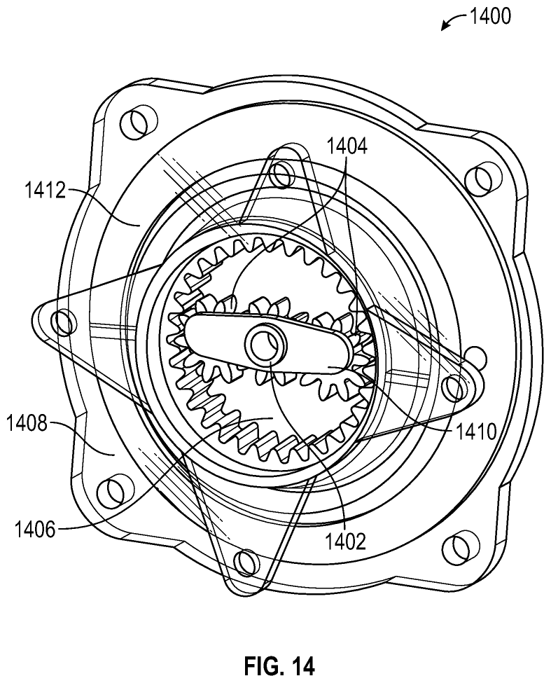

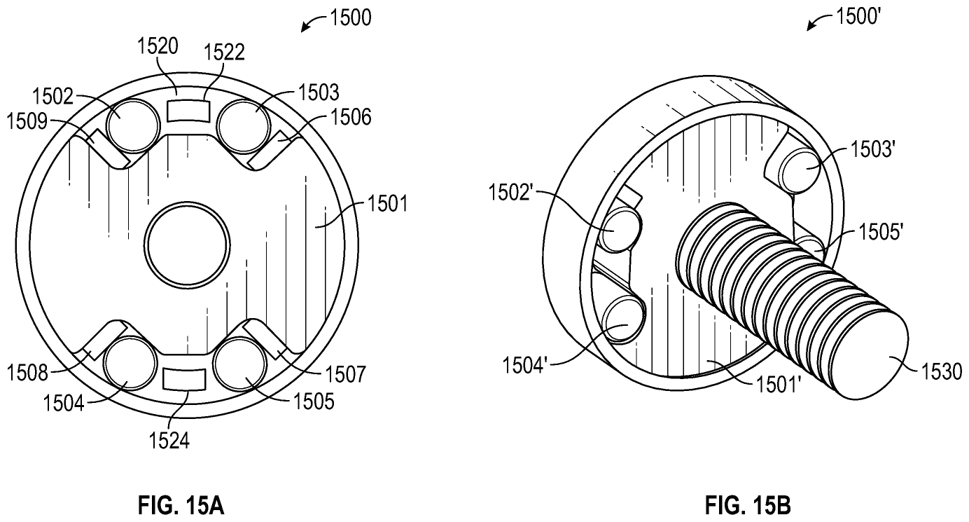

FIG. 14 illustrates the structure of an exemplary planetary transmission that can be used in the above embodiment of the disclosure. The planetary transmission 1400 can include a gear assembly that includes a driven sun gear 1402, multiple planet gears 1404, and an output ring gear 1406. The gear assembly can be housed in a fixed ring gear housing 1408. The planet gears 1404 can be supported by a planet carrier 1410. Thrust washer 1412 can be used in the transmission 1400 to allow the roller clutch and lead screw assembly (see FIG. 15a) to rotate freely from the transmission assembly 1400 while bearing the axial force from the braking action. The rotor of the electric motor (not shown in FIG. 14) can be connected to and drive the driven sun gear 1402. The sun gear can transfer the torque onto the planet gears 1404, which can then engage the output ring gear 1406, as shown in FIG. 14. The output from the output ring gear 1406 can move the lead screw through a roller clutch (both the lead screw and the roller clutch are not shown in FIG. 14). The illustrated planetary transmission has a relatively small thickness, which can allow it to be fit in if the space between the electric motor and the friction brake is limited. Though, it should be understood that other type of transmission assemblies can also be used to achieve the same purpose.

FIG. 15a illustrates an exemplary structure of the roller clutch of FIG. 13, according to an embodiment of the disclosure. As shown in FIG. 13, the roller clutch 1303 can be connected to the transmission 1302. Referring to FIG. 15a, the roller clutch 1500 can include a center plate 1501 that is locked in a position by 4 rollers 1502, 1503, 1504, 1505. Although 4 rollers are illustrated in this example, it should be understood that any number of rollers can be included in the clutch. Each roller 1502, 1503, 1504, 1505 is forced against the internal wall 1520 of the roller clutch 1303 by a corresponding spring roller cap 1509, 1506, 1508, 1507 to prevent the center plate 1501 from rotating in either direction. A pair of tabs 1522, 1524 can disengage the rollers 1502, 1503, 1504, 1505 by retracting the rollers so that they are no longer blocking the center plate 1501 from rotating in one or the other direction. For example, opposite rollers 1502 and 1505 can be retracted to allow the center plate 1505 to rotate in a clockwise direction. Similarly, opposite rollers 1503 and 1504 can be retracted to allow the center plate 1505 to rotate in a counter-clockwise direction.

FIG. 15b is a perspective view of the same roller clutch 1500′ of FIG. 15. It shows the 4 rollers 1502′, 1503′, 1504′, 1505′ in the lock position to prevent the center plate 1501′ from rotating in any direction. A lead screw 1530 is shown to protrude from the center plate 1501′ of the roller clutch 1500′. When the rollers are in the lock position, the lead screw remains stationary. When 2 opposite rollers are retracted from their locked position (as discussed above), the center plate 1501′ can rotate in one direction, which could turn the lead screw 1530 in the same direction.

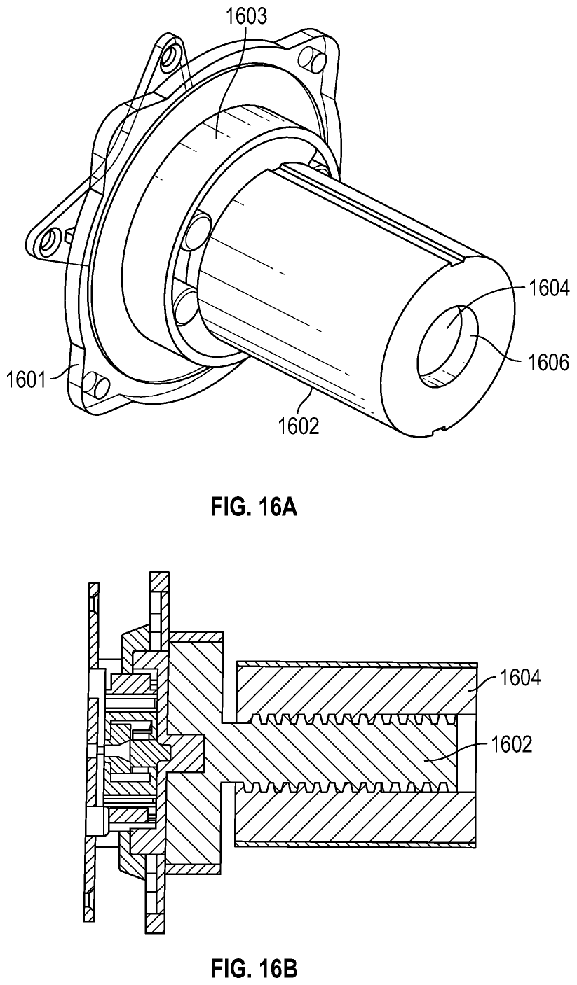

FIG. 16a provides a perspective view of a transmission 1601, roller clutch assembly 1603 and a piston 1602 that can be pushed using the torque transmitted from the transmission and roller clutch assembly. The transmission 1601 and the roller clutch 1603 can be the same as the ones shown in FIGS. 14, 15a and 15b. The lead screw 1604 can be fitted inside a center hole 1606 of the piston 1602. As the roller clutch is released from its locked position, the transmission can use the torque received from the electric motor (not shown in FIG. 16a) to rotate the center plate of the roller clutch, thereby turning the lead screw 1604 such that it is retracted from the hole in the piston. When retracting the piston, the lead screw can go further into the hole of the piston. The piston is constrained rotationally and is forced to move axially as a result. The axial movement of the piston can engage the friction brake mechanism shown in FIG. 11 and discussed above

FIG. 16b provides a side view of the same assembly of FIG. 16a.

FIGS. 11-16b illustrates a friction brake system that uses braking torque generated by an electric motor to engage and disengage brake pads to cause braking effect on a vehicle. Embodiments of the system disclose above do not require components of a hydraulic braking system such as hydraulic fluids. They rely on electric power instead and are capable of producing the same or similar braking effect as conventional hydraulic systems.

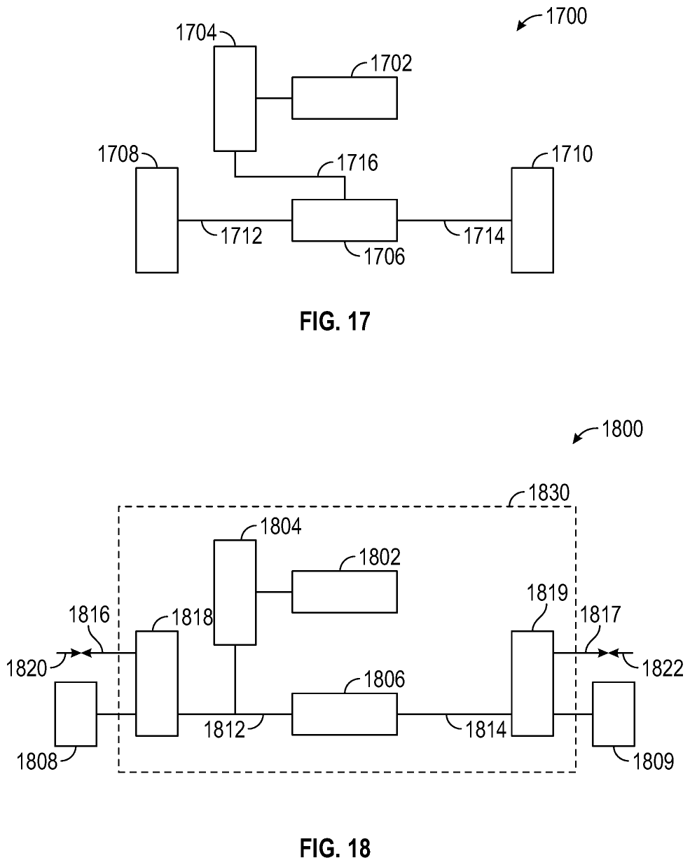

FIG. 17 illustrates an alternative embodiment of the vehicle brake unit of FIG. 3. In this embodiment, the vehicle brake unit 1700 includes an electric motor 1702, a reduction gear 1704, a differential 1706, and a pair of electro-mechanical brakes 1708, 1710. The electric motor 1702 can be the same or similar as the motor illustrated in FIG. 3. Specifically the electric motor 1702 can be connected to the reduction gear 1704, which can reduce the rotations per minute (RPM) output by the electric motor 1702. In one example, the RPM can be reduced by ⅔. That is, the output of the reduction gear 1704 can have an RPM that is ⅓ of what is received by the reduction gear 1704 from the electric motor 1702.

The output of the reduction gear 1704 is connected via a shaft 1716 to a differential 1706 such as the open differential of FIG. 3, which is, in turn, connected to two output shafts 1712, 1714, each of which is responsible for causing a corresponding wheel (not shown in FIG. 7) to turn and/or brake. The differential 1706 splits the torque from the electric motor and transfers it over two output shafts 1712, 1714. Each of the output shafts 1712, 1714 can be acted on by a corresponding electro-mechanical brake 1708, 1710. For example, electro-mechanical brake 1708 can generate a braking force to slow down and/or stop the rotation of output shaft 1712. Similarly, electro-mechanical brake 1710 can generate a braking force to slow down and/or stop the rotation of output shaft 1714. The electric-mechanical brakes 1708, 1710 can be friction brakes each controlled by a corresponding electric motor (not shown in FIG. 7). In one embodiment, the shaft 1716 and one of the output shaft 1712, 1714 can be the same shaft.

Optionally, a hub reduction gear (not shown in FIG. 17) can be incorporated in the wheel hub of each wheel that is connected to each of the shafts 1712, 1714. The hub reduction gear(s) can further reduce the output RPM of the electric motor 1702. In this example, by including a reduction gear 1704 between the output of the electric motor 1702 and the differential 1706 and the optional hub reduction gear mention above, the required brake torque for the electro-mechanical brakes 1708, 1710 is a fraction of what is required without the reduction gear 1704 or the optional hub reduction gear.

FIG. 18 illustrates another alternative embodiment of the vehicle brake unit of FIG. 3. In this embodiment, the vehicle brake unit 1800 includes an electric motor 1802, a first reduction gear 1804, a differential 1806, a pair of second reduction gears 1818, 1819, and a pair of electro-mechanical brakes 1808, 1810. The electric motor 1802 can be the same or similar as the motor 1702 illustrated in FIG. 17. Specifically the electric motor 1802 can be connected to the reduction gear 804, which can reduce the rotations per minute (RPM) output by the electric motor 1802. In one example, the RPM can be reduced by ⅔. That is, the output of the reduction gear 1804 can have an RPM that is ⅓ of what is received by the reduction gear 1804 from the electric motor 1802.

The output of the reduction gear 1804 is transmitted via a shaft 1812 to a differential 1806 such as the open differential of FIG. 3. The differential 1806 can have two output shafts 1812, 1814, each of which is connected to a corresponding brake 1808, 1809. In the illustrated embodiment of FIG. 18, one of the output shaft 1812 of the differential 1806 can be the same shaft connected the first reduction gear 1804 to the differential 1806. In other embodiments, two separate shafts can be used. The differential 1806 splits the torque from the electric motor and transfers it over two output shafts 1812, 1814. Each of the output shafts 1812, 1814 can be acted on by a corresponding electro-mechanical brake 1808, 1810. For example, electro-mechanical brake 1808 can generate a braking force to slow down and/or stop the rotation of output shaft 1812. Similarly, electro-mechanical brake 1810 can generate a braking force to slow down and/or stop the rotation of output shaft 1814. The electric-mechanical brakes 1808, 1810 can be friction brakes each controlled by a corresponding electric motor (not shown in FIG. 18).

Unlike the embodiment illustrated in FIG. 7, a pair of second reduction gears 1818, 1819 are incorporated into the brake system 1800 by being linked to the two output shafts 1812, 1814 of the differential 1806, respectively. Each of the second reduction gears 1818, 1819 can further reduce the RPM output by the electric motor 1802. In one example, the RPM can be further reduced by ⅔. That is, each of the output of the reduction gears 1818, 1819 can achieve 1/9 of the original output RPM of the electric motor 1802. The reduced RPM can then be output through respective output shafts 1816, 1817 to the respective wheels 1820, 1822. In some embodiments, the RPMs received by each of the second reduction gears 1818, 1819 can be different depending on the output of the differential. Accordingly, the output RPMs to the wheels 1820, 1822 can also be different. Although the pair of second reduction gears 1818, 1819 can be the same of similar gear or combination of gears, it should be understood that they can also be different. Furthermore, the second reduction gears 1818, 1819 can be the same as or different from the first reduction gear 804.

In the embodiment of FIG. 18, the electric motor 1802, first reduction gear 1804, differential 1806, shafts 1812, 1814, and the pair of second reduction gears can be enclosed in a single physical module 1830 to minimize the space required by these components. This allows the module 1830 to be easily incorporated into any traditional vehicle design without requiring too many modifications to the vehicle.

Overall, the integrated drive/brake systems and methods of the disclosed embodiments can replace the conventional hydraulic system. Because fewer parts are required and the size of the brake mechanisms can be reduced by incorporating transmissions that amplifies braking effect in the system without sacrificing brake performance, the disclosed embodiments can take less space and save overall mass of the vehicle, thereby reducing cost of the vehicle. The integrated drive/brake system can also provide drive arrangement flexibility among FWD, AWD, and RWD and fully replace existing hydraulic brake system, ESC, and ABS. Furthermore, because the disclosed embodiments are fully digitized systems using electrical control rather than analog controls, it can be easily integrated with other digital system such as semi or full autonomous systems of the vehicle.

In one embodiment, a brake blending method for a vehicle is disclosed. The vehicle includes an electric motor for powering the vehicle, a friction brake, a regenerative brake, and an induction brake. The method includes: setting an RPM of the electric motor below which the friction brake is mandatory when applying braking to the vehicle; detecting an operating RPM of the electric motor of the vehicle; determining, based on the detected operating RPM of the electric motor, whether each of the friction brake, regenerative brake, and induction brake needs to be engaged or disengaged; and engaging or disengaging each of the friction brake, regenerative brake, and induction brake based on the determination; wherein the regenerative brake is maximized at any RPM of the electric motor.

In another embodiment, a brake control system for a vehicle is disclosed. The vehicle includes an electric motor for powering the vehicle, a friction brake, a regenerative brake, and an induction brake. The brake control system includes: a RPM detecting module configured to detect an operating RPM of the electric motor of the vehicle; a brake blending module connected to the RPM detecting module and configured to determine, based on the detected operating RPM of the electric motor, whether each of the friction brake, regenerative brake, and induction brake needs to be engaged or disengaged; a friction brake control module connected to the brake blending module and configured to engage or disengage the friction brake based on the determination; a regenerative brake control module connected to the brake blending module and configured to engage or disengage the regenerative brake based on the determination; and an induction brake control module connected to the brake blending module and configured to engage or disengage the induction brake based on the determination; wherein the regenerative brake is maximized at any RPM of the electric motor.

In another embodiment, a driving unit is disclosed. The driving unit includes: a motor comprising a motor shaft; an housing of a differential, a first part of the housing coupled to the motor shaft by a first spline; a first set of planet gears connecting the differential housing and a first sun gear coupled to a right driving shaft; a second set of planet gears connecting the differential housing and a second sun gear coupled to a left driving shaft; a second spline coupling the first sun gear to the right driving shaft; and a third spline coupling the second sun gear to the left driving shaft. The driving unit of this embodiment can further include: a first needle bearing placed between the first sun gear and a first part of the housing of the differential; a second needle bearing placed between the second sun gear and the inverter housing; and a third needle bearing placed between the internal surface of the motor shaft and the right driving shaft. Alternatively, the driving unit of this embodiment can also include: a first ball bearing placed between a housing of the motor and the motor shaft; a second ball bearing placed between the housing of the motor and the housing of the differential; a third ball bearing placed between the housing of the inverter and the housing of differential; and a forth ball bearing placed between the housing of the inverter and the left driving shaft.

In yet another embodiment, a fiction brake actuator assembly is disclosed. The assembly includes: a planetary gearbox connected to an electric motor; a roller clutch connected to the planetary gearbox; a lead screw protruding from a central plate of the roller clutch; a piston receiving the lead screw; and a brake configured to be engaged and disengaged in response to movement of the piston. In this embodiment, the planetary transmission can include: a thrust washer; a driven sun gear configured to be driven by the electric motor; one or more planet gears connected to the driven sun gear; and an output ring gear connected to the one or more planet gears, the output ring gear housed in a fixed ring gear housing. Furthermore, the roller clutch of this embodiment can further include: a plurality of retractable rollers; a plurality of spring roller caps, each spring roller cap in contact with one or the plurality of rollers; a rotatable center plate configured to be in an unlocked position when at least two of the rollers are retracted; and one or more tabs, each configured to retract and extend one or more of the rollers.

In yet another embodiment, a brake system of a vehicle is disclosed. The system includes: an electric motor configured to generate torque; a reduction gear connected to the electric motor and configured to reduce a revolution per minute (RPM) of an output of the electric motor; and a differential connected to the reduction gear and configured to split the torque generated by the electric motor between a first and a second electro-mechanical brakes. The brake system of this embodiment can further include a hub reduction gear connected to each of the first and second electro-mechanical brakes.

In yet another embodiment, a brake system of a vehicle is disclosed. The brake system can include: an electric motor configured to generate torque; a first reduction gear connected to the electric motor and configured to reduce a revolution per minute (RPM) of an output of the electric motor; a differential connected to the first reduction gear and configured to split the torque generated by the electric motor between a first and a second electro-mechanical brakes; and a pair of second reduction gears connected to outputs of the differential and configured to further reduce the RPM of the electric motor. In this embodiment, the electric motor, the first reduction gear, the differential, and the pair of second reduction gears can be enclosed in a single module.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A brake system of a vehicle, comprising:
a sensor configured to transmit a signal;
a brake control unit (BCU) connected to the sensor and configured to determining a braking torque in response to the received signal;
an electric traction motor and multiple electric motors within friction brake mechanism working as actuators connected to the BCU and configured to generate the braking torque;
a regenerative braking mechanism and a frictional braking mechanism configured to be actuated in parallel and work cooperatively to deliver required brake force; and
a transmission situated between the braking mechanism and the wheel and configured to amplify the braking effect.

2. A vehicle braking method comprising:
receiving a signal from a sensor;
determining an amount of braking effect based on the signal;
generating a braking torque in response to the determined braking effect;
actuating a braking mechanism to create a braking effect using the generated braking torque; and
amplifying the braking effect by a transmission before applying the braking effect to a wheel.

3. A vehicle comprising:
a first, second, third, and fourth wheels;
a first electric motor and a second electric motor;
a first differential connecting the first electric motor to a first and a second braking mechanisms;
a second differential connecting the second electric motor to a third and a fourth braking mechanisms;
a brake control unit (BCU) connected to the first and second electric motors and configured to transmit a first and second braking requirements to the first electric motor and transmit a third and fourth braking requirements to the second electric motor, the first electric motor generating based on the first and second braking requirements, respectively, a first and a second torque for braking the first and second wheels, respectively, the second electric motor generating based on the third and fourth braking requirements, a third and a fourth torque for braking the third and fourth wheels; and
a first, second, third, and fourth transmissions connected to the first, second, third, and fourth wheels, respectively, the first, second, third, and fourth transmissions configured to amplify braking effects on the first, second, third, and fourth wheels, respectively.
